(19) United States
(12) Patent Application Publication
(10) Pub. No.: US 2006/0015338 A1
(43) Pub. Date: Jan. 19, 2006

(54) Voice recognition method with automatic correction

(76) Inventor: Gilles Poussin, Merignac (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/527,132

(22) PCT Filed: Sep. 19, 2003
(86) PCT No.: PCT/FR03/02770

§ 371 Date: Mar. 8, 2005

(30) Foreign Application Priority Data
Sep. 24, 2002 (FR) 02/11789

(51) Int. Cl. G10L 15/04

(52) U.S. Cl. 704/251

(57) ABSTRACT

The present invention relates to a method of voice recognition with automatic correction in voice recognition systems with constrained syntax. It comprises in particular a step of processing said speech signal delivering a signal in a compressed form, a step of recognizing patterns so as to search, on the basis of a syntax formed of a set of phrases which represent the set of possible paths between a set of words prerecorded during a prior phase, for a phrase of said syntax that is the closest to said signal in its compressed form, the storage of the signal in its compressed form, the generation of a new syntax in which the path corresponding to said phrase determined during the earlier recognition step is precluded, the repetition of the step of recognizing patterns so as to search, on the basis of the new syntax, for another phrase which is the closest to said stored signal.

The present invention relates to a method of voice recognition with automatic correction in voice recognition systems with constrained syntax, that is to say the recognizable phrases lie in a set of determined possibilities. This method is particularly suitable for voice recognition in noisy surroundings, for example in the cockpits of civil or fighter aircraft, in helicopters or in motoring.

Numerous works in the field of voice recognition with constrained syntax have made it possible to obtain recognition rates of the order of 95%, doing so even in the noisy environment of a fighter aircraft cockpit (approximately 100-110 dBA around the pilot's helmet). However, this performance is not sufficient to make voice command into a primary command medium for parameters that are critical from the flight safety point of view.

A strategy used consists in submitting the critical commands to a validation of the pilot, who verifies through the phrase recognized that the right values will be assigned to the right parameters (“primary feedback”). In case of error of the recognition system—or pilot enunciation error—the pilot must say the whole phrase again, and the probability of error in the recognition of the phrase enunciated again is the same. Thus for example, if the pilot says “Select altitude two five five zero feet”, the system performs the recognition algorithms and provides the pilot with visual feedback. By envisaging the case where an error occurs, the system will for example propose “SEL ALT 2 5 9 0 FT”. In a conventional system, the pilot must then enunciate the whole phrase again, with the same probabilities of error.

An error correction system which is better in terms of recognition rate consists in having the pilot enunciate a correction phrase which will be recognized as such. For example, returning to the above example, the pilot may say “Correction third digit five”. However, this procedure increases the pilot's workload in the recognition method, this being undesirable.

Known from the prior art, see for example U.S. Pat. No. 6,141,661, is a method of voice recognition of an identifier from among a prerecorded set of identifiers, in which if a first identifier has been recognized and then invalidated by the user, the voice recognition is repeated, deleting the first identifier from said set. This method cannot be applied however to the voice recognition of phrases, which form too large a number of combinations to be prerecorded.

The invention proposes a method of voice recognition which implements automatic correction of the phrase enunciated making it possible to obtain a recognition rate of close to 100%, without increasing the pilot's load.

Accordingly, the invention relates to a method of voice recognition of a speech signal uttered by a speaker with automatic correction, comprising in particular a step of processing said speech signal delivering a signal in a compressed form, a step of recognizing patterns so as to search, on the basis of a syntax formed of a set of phrases which represent the set of possible paths between a set of words prerecorded during a prior phase, for a phrase of said syntax that is the closest to said signal in its compressed form, and characterized in that it comprises
the storage (16) of the signal in its compressed form,
the generation (17) of a new syntax (SYNT2) in which the path corresponding to said phrase determined during the earlier recognition step is precluded,
the repetition of the step of recognizing patterns so as to search, on the basis of the new syntax, for another phrase that is the closest to said stored signal.

Other advantages and characteristics will become more clearly apparent on reading the following description, illustrated by the appended figures which represent:

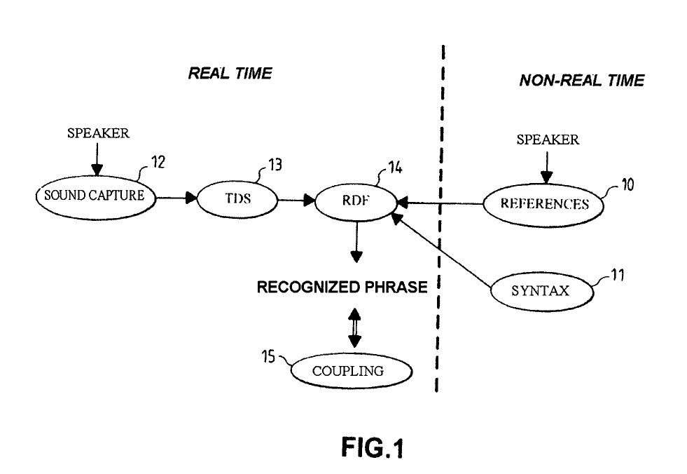

FIG. 1, the basic diagram of a voice recognition system of known type;

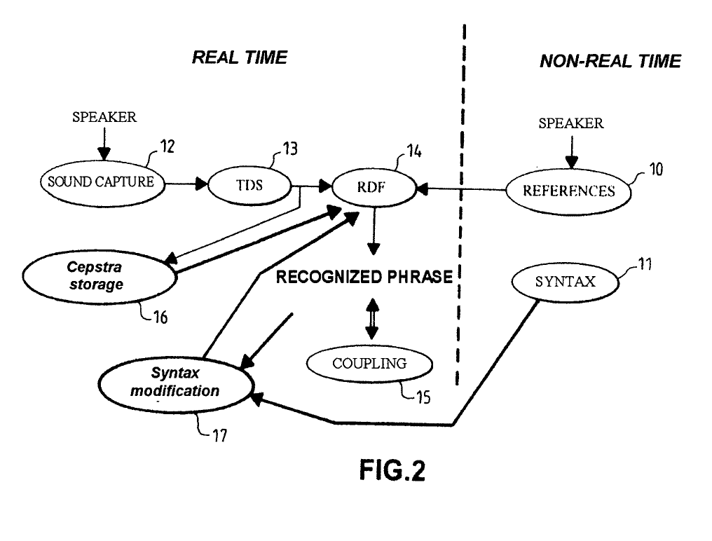

FIG. 2, the diagram of a voice recognition system of the type of that of FIG. 1 implementing the method according to the invention;

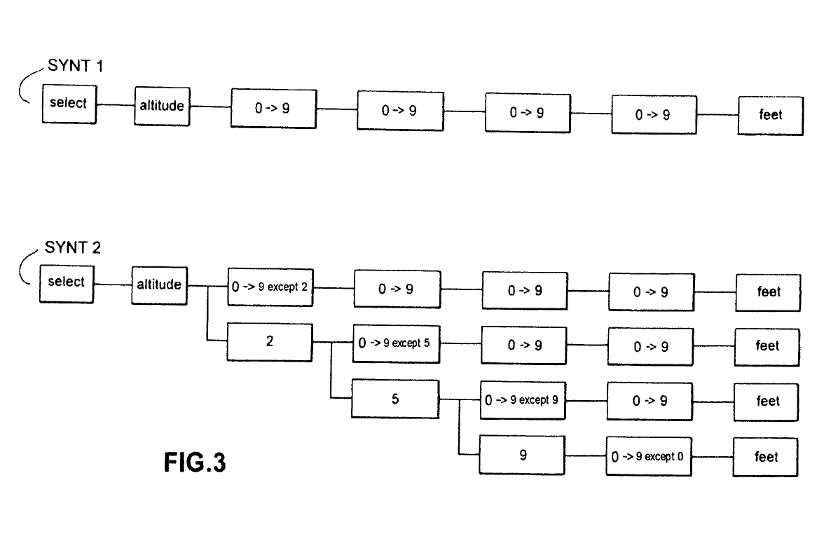

FIG. 3, a diagram illustrating the modification of the syntax in the method according to the invention.

In these figures, identical elements are referenced by the same labels.

FIG. 1 presents the basic diagram of a voice recognition system with constrained syntax of known type, for example an onboard system in a very noisy environment. In a single-speaker constrained syntax system, a non-real-time learning phase allows a given speaker to record a set of acoustic references (words) stored in a space of references 10. The syntax 11 is formed of a set of phrases which represent the set of possible paths or transitions between the various words. Typically, some 300 words are recorded in the reference space which typically form 400 000 possible phrases of the syntax.

Conventionally, a voice recognition system comprises at least three blocks as illustrated in FIG. 1. It comprises a speech signal acquisition (or sound capture) block 12, a signal processing block 13 and a pattern recognition block 14. A detailed description of this whole set of blocks according to one embodiment is found for example in French patent application FR 2 808 917 in the name of the applicant.

In a known manner, the acoustic signal processed by the sound capture block 12 is a speech signal picked up by an electroacoustic transducer. This signal is digitized by sampling and chopping into a certain number of overlapping or non-overlapping frames, of like or unlike duration. In the signal processing block 13, each frame is conventionally associated with a vector of parameters which conveys the acoustic information contained in the frame. There are several procedures for determining a vector of parameters. A conventional example of a procedure is that which uses the cepstral coefficients of MFCC type (the abbreviation standing for the expression “Mel Frequency Cepstral Coefficient”). The block 13 makes it possible to determine initially the spectral energy of each frame in a certain number of frequency channels or windows. For each of the frames it delivers a value of spectral energy or spectral coefficient per frequency channel. It then performs a compression of the spectral coefficients obtained so as to take account of the behavior of the human auditory system. Finally, it performs a transformation of the compressed spectral coefficients, these transformed compressed spectral coefficients are the parameters of the sought-after vector of parameters.

The pattern recognition block 14 is linked to the space of references 10. It compares the series of parameter vectors that emanates from the signal processing block with the references obtained during the learning phase, these references conveying the acoustic fingerprints of each word, each phoneme, more generally of each command and which will be referred to generically as a “phrase” subsequently in the description. Since the pattern recognition is performed by comparison between parameter vectors, these basic parameter vectors must be at one's disposal. They are obtained in the same manner as for the useful-signal frames, by calculating for each basic frame its spectral energy in a certain number of frequency channels and by using identical weighting windows.

On completion of the last frame, this generally corresponding to the end of a command, the comparison gives either a distance between the command tested and reference commands, the reference command exhibiting the smallest distance is recognized, i.e. a probability that the series of parameter vectors belong to a string of phonemes. The algorithms conventionally used during the pattern recognition phase are in the first case of DTW type (the abbreviation standing for the expression Dynamic Time Warping) or, in the second case of HMM type (the abbreviation standing for the expression Hidden Markov Models). In the case of an HMM type algorithm, the references are Gaussian functions each associated with a phoneme and not with series of parameter vectors. These Gaussian functions are characterized by their center and their standard deviation. This center and this standard deviation depend on the parameters of all the frames of the phoneme, that is to say the compressed spectral coefficients of all the frames of the phoneme.

The digital signals representing a recognized phase are transmitted to a device 15 which carries out the coupling with the environment, for example by displaying the recognized phrase on the head-up viewfinder of an aircraft cockpit.

As explained previously, for critical commands, the pilot can have at his disposal a validation button allowing the execution of the command. In the case where the phrase recognized is erroneous, he must generally repeat the phrase with an identical probability of error.

The method according to the invention allows automatic correction of great efficacy which is simple to implement. Its installation into a voice recognition system of the type of FIG. 1 is shown diagrammatically in FIG. 2.

According to the invention, on completion of the signal processing phase 13, the speech signal is stored (step 16) in its compressed form (set of parameter vectors also referred to as “cepstra”) . As soon as a phrase is recognized, a new syntax is generated (step 17), in which the phrase recognized is no longer a possible path of the syntax. The pattern recognition phase is then repeated with the signal stored but on the new syntax. Preferably, the pattern recognition is repeated systematically to prepare another possible solution. If the pilot detects an error in the command recognized, he presses for example a specific correction button, or briefly depresses or double clicks the voice command speak/listen switch and the system prompts him with the new solution found during the repetition of the pattern recognition. The above steps are repeated to generate new syntaxes which preclude all the solutions previously found. When the pilot sees the solution which actually corresponds to the phrase uttered, he gives the OK through any means (button, voice, etc.).

Let us return to the example cited previously as benefiting from the invention. According to this example the pilot says “Select altitude two five five zero feet”. The system performs the recognition algorithms and, for example on account of ambient noise, recognizes “Select altitude two five nine zero feet”. Visual feedback is given to the pilot: “SEL ALT 2 5 9 0 FT”. While the speaker is engaged in reading the phrase recognized, the system anticipates a possible error by automatically generating a new syntax in which the phrase recognized is deleted and by repeating the pattern recognition step.

FIG. 3 illustrates by a simple diagram, in the case of the previous example, the modification of the syntax allowing with a pattern recognition algorithm of DTW type the search for a new phrase. The phrase uttered by the speaker according to the above example is “SEL ALT 2 5 5 0 FT”. We assume that the phrase recognized by the first pattern recognition phase is “SEL ALT 2 5 9 0 FT”. This first phase calls upon the original syntax SYNT1, in which all the combinations (or paths) are possible for the four digits to be recognized. During a second pattern recognition phase, the phrase recognized is discarded from the possible combinations, thus modifying the syntactic tree as is illustrated in FIG. 3. A new syntax is generated which precludes the path corresponding to the solution recognized. A second phase is then recognized. The pattern recognition phase may be repeated with, each time, generation of a new syntax which borrows the previous syntax but in which the previously found phrase is deleted.

Thus, the new syntax is obtained by reorganizing the earlier syntax in such a way as to particularize the path corresponding to the phrase determined during the earlier recognition step, then by eliminating this path. This reorganization is done for example by traversing the earlier syntax as a function of the words of the previously recognized phrase and by forming in the course of this traversal the path specific to this phrase.

In a possible mode of operation, the pilot indicates to the system that he wants a correction (for example by briefly depressing the voice command speak/listen switch) and as soon as a new solution is available, it is displayed. The automatic search for a new phrase is stopped for example when the pilot gives the OK to a recognized phrase. In our example, it is probable that right from the second pattern recognition phase, the pilot sees “SEL ALT 2 5 5 0 FT”. He can then give the OK to the command. Insofar as numerous recognition errors are due to confusions between words akin to one another (for example, five-nine), the invention makes it possible to correct these errors almost assuredly with a minimum of additional workload for the pilot and very fast on account of the anticipation regarding the correction that the method according to the invention may perform.

Furthermore, by generating a new syntax and by repeating the pattern recognition step on the new syntax, the complexity of the syntactic tree is not increased. The processing algorithm can therefore perform recognition with a similar lag at each iteration, this lag being imperceptible to the pilot on account of the anticipation of the correction.

1. A method of voice recognition of a speech signal uttered by a speaker with automatic correction, steps of:
processing said speech signal and delivering a signal in a compressed form;
recognizing patterns so as to search, on the basis of a syntax formed of a set of phrases which represent the set of possible paths between a set of words prerecorded during a prior phase, for a phrase of said syntax that is the closest to said signal in its compressed form;
storing the signal in its compressed form,
generating a new syntax in which the path corresponding to said phrase determined during the earlier recognition step is precluded,
repeating the step of recognizing patterns so as to search, on the basis of the new syntax, for another phrase that is the closest to said stored signal.

2. The method of voice recognition as claimed in claim 1, in which the new syntax is obtained by reorganizing the earlier syntax in such a way as to particularize said path corresponding to the phrase determined during the earlier recognition step, then eliminating this path.

3. The method of voice recognition as claimed in claim 2, in which said reorganization is effected by traversing the earlier syntax as a function of the words of said phrase and formation in the course of this traversal of the path specific to said phrase.

4. The method of voice recognition as claimed in claim 1, characterized in that wherein the search for a new phrase is repeated systematically to anticipate the correction.

5. The method of voice recognition as claimed in claim 4, wherein each new phrase recognized is proposed to the speaker on the request thereof.

6. The method of voice recognition as claimed in claim 4, wherein the search for a new phrase is halted by validation of a phrase recognized by the speaker.

7. The method of voice recognition as claimed in claim 1, characterized in that wherein the processing step comprises:
digitizing and chopping into a string of time frames of said acoustic signal,
a phase of parameterization of time frames containing the speech so as to obtain, per frame, a vector of parameters in the frequency domain, the whole set of these parameter vectors forming said signal in its compressed form.

8. The method of voice recognition as claimed in claim 7, wherein the pattern recognition calls upon an algorithm of DTW type.

9. The method of voice recognition as claimed in claim 7, wherein the pattern recognition calls upon an algorithm of HMM type.

10. The method of voice recognition as claimed in claim 2, wherein the search for a new phrase is repeated systematically to anticipate the correction.

11. The method of voice recognition as claimed in claim 3, wherein the search for a new phrase is repeated systematically to anticipate the correction.

12. The method of voice recognition as claimed in claim 5, wherein the search for a new phrase is halted by validation of a phrase recognized by the speaker.

13. The method of voice recognition as claimed in claim 2, wherein the processing step comprises:
digitizing and chopping into a string of time frames of said acoustic signal,
a phase of parameterization of time frames containing the speech so as to obtain, per frame, a vector of parameters in the frequency domain, the whole set of these parameter vectors forming said signal in its compressed form.

14. The method of voice recognition as claimed in claim 3, wherein the processing step comprises:
digitizing and chopping into a string of time frames of said acoustic signal,
a phase of parameterization of time frames containing the speech so as to obtain, per frame, a vector of parameters in the frequency domain, the whole set of these parameter vectors forming said signal in its compressed form.

15. The method of voice recognition as claimed in claim 4, wherein the processing step comprises:
digitizing and chopping into a string of time frames of said acoustic signal,
a phase of parameterization of time frames containing the speech so as to obtain, per frame, a vector of parameters in the frequency domain, the whole set of these parameter vectors forming said signal in its compressed form.

16. The method of voice recognition as claimed in claim 5, wherein the processing step comprises:
digitizing and chopping into a string of time frames of said acoustic signal,
a phase of parameterization of time frames containing the speech so as to obtain, per frame, a vector of parameters in the frequency domain, the whole set of these parameter vectors forming said signal in its compressed form.
